(19) United States
(12) Patent Application Publication
(10) Pub. No.: US 2011/0145032 A1
(43) Pub. Date: Jun. 16, 2011

(54) Workforce management system for forecasting and scheduling work items that cross intervals

(76) Inventor: William Nathan Stearns, Arlington, TX (US)

(21) Appl. No.: 12/636,804

(22) Filed: Dec. 14, 2009

(51) Int. Cl. G06Q 10/00

(52) U.S. Cl. 705/7.13; 705/7.25

(57) ABSTRACT

A forecast and plan generation process for a workforce management (WFM) system implements an algorithm to calculate staffing requirements when average handling time (AHT) is longer than a data collection statistics period and/or a work item is in progress of being handled in more than one interval. A schedule generation process schedules an agent for intervals after a work item is provided/connected to the agent, preferably up to an including an interval when the work item terminates (based on the AHT of the work item and a simulated arrival time of the work item). Additional agents are scheduled for new work items that are forecasted to arrive in an interval, in addition to the agents that may already be connected to a contact.

### BACKGROUND OF THE INVENTION

1. Technical Field

The present invention relates generally to computer-implemented agent or employee scheduling in a work environment.

2. Background of the Related Art

Workforce management (WFM) systems are well-known in the prior art. Such systems integrate many management functions, such as workforce forecasting and scheduling, skill planning and scheduling, multimedia contact management, real-time schedule adherence, and the like. A representative commercial system of this type is TotalView®, from IEX Corporation. Such systems generate forecasts of contact received volumes and contact handling times based on historical data to determine how much staff will be needed at different times of the day and week; they then create schedules that match the staffing to the anticipated needs.

Traditional WFM systems typically calculate interval-based staffing requirements using three (3) inputs: number of work items (e.g., contacts), average handling time (AHT), and a service objective (such as service level, occupancy, and the like). When AHT is less than a statistics interval (typically 15 or 30 minutes) or a work item does not cross from one interval to the following interval(s), the calculation of staffing requirements is accurate. When the AHT is longer than the interval or a work item does cross from one interval to the following interval(s), however, the staffing requirement calculation may well be either overstated or understated for that interval. Thus, for example, assume that there are two (2) work items forecasted in a thirty minute interval at sixty minute AHT, which may be typical in a back office work environment. The workload is then calculated by traditional methods as follows: [(2×60 minutes)/30 minutes]=4 FTE (full time equivalent) units for the 30 minute interval. In a work environment involving real people, however, four (4) individuals cannot work the two (2) work items in the 30 minute interval. Rather, a true staffing requirement is two 2 FTE for the 30 minute interval and the same two (2) FTE for the next 30 minute interval.

A related problem concerns creation of schedules. Schedule generation programs create schedules to match a staff requirement per interval (typically based on a net staffing analysis). The basic assumption of existing schedule generation programs is that if an agent is scheduled in one period and handles work items in that period, the agent is available to handle new work items any time in the following periods for which the agent is scheduled. When AHT for a work item crosses into the following interval, however, the agent actually is not able to handle new work items in the following period for the simple reason that the agent must be assumed to be fully engaged with an existing contact (that may continue through multiple periods). Therefore, existing scheduling algorithms tend to assume an agent contributes to handling new work items arriving in an interval when, in reality, the agent is not able to handle new work items during such interval(s).

### BRIEF SUMMARY

The subject disclosure solves the problem of overstating or understating FTE units by a method that distributes work time and work item assignments over a number of intervals.

According to a further embodiment, a schedule generation process schedules an agent for intervals after a work item is provided/connected to the agent, preferably up to and including an interval when the work item terminates (preferably based on the AHT of the work item and a simulated arrival time of the contact). Additional agents are scheduled for new work items that are forecasted to arrive in an interval in addition to the agents that may already be connected to handle a work item.

The foregoing has outlined some of the more pertinent features of the invention. These features should be construed to be merely illustrative. Many other beneficial results can be attained by applying the disclosed invention in a different manner or by modifying the invention as will be described.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is an illustrative workforce management center in which the subject disclosure may be implemented; and

FIG. 2 is a table illustrating how in a first embodiment the disclosed algorithm for FTE calculation with long average handling time (AHT) works in a representative environment for immediate response work items;

FIG. 3 demonstrates the output of a scheduling process for a particular set of agents that illustrates which agents of a set of agents might handle the work items generated by the requirement calculation of FIG. 2;

FIG. 4 is a table illustrating how in a second embodiment the disclosed algorithm for FTE calculation with long AHT works for so-called deferrable response work items; and

FIG. 5 is the output of a scheduling process for a particular set of agents that illustrates which agents of a set of agents might handle the work items generated by the calculation of FIG. 4.

### DETAILED DESCRIPTION

In the following discussion, the subject matter is described in the context of a contact center environment, although it should be understood that the techniques herein can be practiced in other types of environments such as, without limitation, back office environments, sales force environments, field service environments, manufacturing environments, airports, airlines, government agencies, casinos, banks, financial services institutions, retail stores, warehouses, and other types of environments wherein entities (agents, employees, contractors, other persons, or the like) work according to assigned schedules.

In one embodiment, the subject technique is implemented as an adjunct to a workforce management system. WFM software provides a centralized platform for optimizing the performance of a work environment, such as a back office. A known commercial product is IEX TotalView® workforce management. A WFM solution such as TotalView enables an enterprise to forecast and plan more accurately and to schedule more effectively. In a second embodiment, the subject technique is implemented in a back office-type environment, using the WFM software. When used in a back office environment, for example, the WFM solution manages work volume, determining the appropriate number of staff needed to perform any type or number of back office tasks. The nature of these back office tasks can be quite varied; representative back office tasks include, without limitation, processing medical claims, processing mortgage applications, processing prescriptions, processing product support calls, and the like. In general, the techniques described herein are useful for forecasting and requirements calculations with respect to any type of “work item” to be handled in the traditional contact center or the back office, and the term “back office” should be broadly construed. In a contact center implementation, a work item is sometimes referred to as a “contact.” A back office may be one location, or a set of distributed locations that share communications and computing resource within or across an enterprise, or a set of enterprises. The disclosed techniques are not limited to the application of any particular back office task or implementation scenario. Thus, the term “work item” should be broadly construed and dependent only on the particular application for which the described techniques are implemented. In one context, the “work item” may be the handling of a contact (e.g., an inquiry from an end user), in another context the work item may be a given application task within an enterprise environment, and so forth.

In general, the back office WFM in which the subject disclosure is designed to operate within integrates forecasting, scheduling and planning to simplify service management. After creating a forecast of work item arrivals and when they should be handled, the system then creates schedules designed to ensure that the enterprise has the right personnel covering the right work types at the right time. The techniques that are used in the WFM to that end are presumed here, and they are known to one of ordinary skill in the art. Representative prior art includes U.S. Pat. No. 6,970,829, the disclosure of which is incorporated herein by reference.

Preferably, the subject matter herein is implemented within or in conjunction with a back office toolkit that comprises a suite of software tools that enable data collection and analysis from the back office and provides that data to the WFM system for forecasting, scheduling, change management and performance management. Thus, for example, the back office toolkit may comprise a desktop connection function, together with a management information gateway (MIG). The desktop connection function typically comprises trigger, monitor and process modules to enable the collection and reporting of information from any agent desktop application, which data can then be viewed in the MIG in a meaningful way.

More generally, and as noted above, the disclosed subject matter relates to forecasting and scheduling in any environment in which contacts (or, more generally, “work items”) cross over or bridge multiple “intervals” used for the forecasting and scheduling processes. An “interval” is an arbitrary time period, typically 15 minutes, 30 minutes, 60 minutes, or the like, although shorter or longer intervals are contemplated as well.

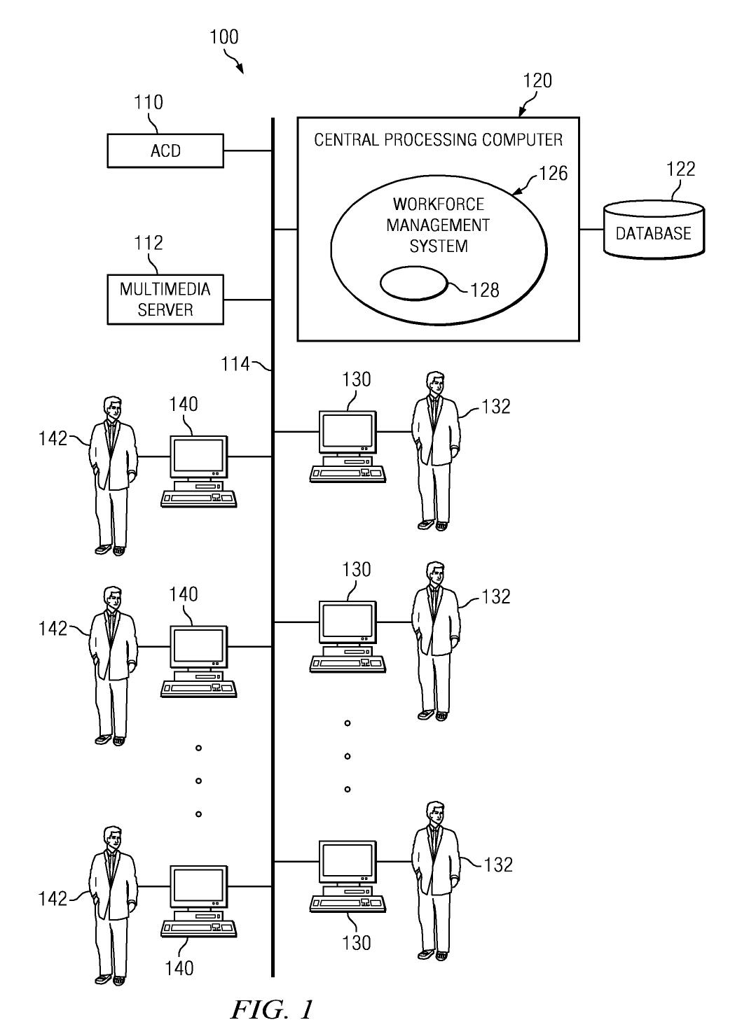

Referring to FIG. 1, the reference numeral 100 generally designates a representative workforce contact center environment. The environment 100 may include an automatic call distributor (ACD) 110 and a multimedia server 112 coupled to a central processing computer 120 via a network 114, such as a wire and/or wireless local area network (LAN), a wire and/or wireless wide area network (WAN), the Internet, an Intranet, or the like. As also described above, the ACD 110 and multimedia server 112 generally provide routing capabilities for incoming voice calls (via the ACD) and other contacts (via the multimedia server). The function and operation of the ACD 110 and multimedia server 112 are considered to be well-known to a person having ordinary skill in the art. The central processing computer 120 receives from the ACD 110 and the multimedia server 112 periodic contact information, such as the number of contacts handled (“in contacts”), the amount of time an agent spends on incoming contacts (“talk time”), the amount of time an agent spends after the talk time for administrative duties related to contact resolution (“work time”), the amount of time an agent spends in talk time and work time (“total time), the amount of time an agent spends available to take a call or handle a contact (“available time”), the amount of time an agent spends in an auxiliary state and/or is unable to take a call (“aux time” and/or “break time”), the number of outgoing contacts made by the agent (“out contacts”), the time spent on the outgoing contacts (“out time”), the elapsed time spent logged into the system (e.g., multimedia server, ACD, or the like) (“system time”), and the like, and preferably stores the information in a database 122 coupled to the central processing computer 120, preferably but not limited to 15 or 30 minute intervals or real time. A workforce management system 126 provides workforce forecasting and scheduling, skill planning and scheduling, multimedia contact management, and the like. While the database 122 is shown external to the computer, one skilled in the art will appreciate that the database 122 may be included within the central processing computer 120, or that the data be retrieved from any other location when needed. The central processing computer 120 is also coupled via the network 114 to one or more agent workstations 130 and to one or more supervisor workstations 140, which provide an interface between the network 114 and one or more agents 132 and supervisors 142, respectively. The agent workstations 130 and the supervisor workstations 140 are preferably configured to access the central processing computer 120 through the network 114 via a browser, such as a Java-enabled web browser, a Windows-based application, or any other client technology. As is well-known, agents 132 access, via the telephone (not shown) and agent workstation 130, the ACD 110, multimedia server 112, or other contact servers (not shown) to aid in contact resolution. As the agents 132 service the contacts, the ACD 110 and the multimedia server 112 collect performance and other data for each of the agents 132. The performance data of the agents 132, such as the in contacts, talk time, work time, total time, available time, aux time, out contacts, out time, system time, and the like, are sent periodically by the ACD 110 and the multimedia server 112 to the central processing computer 120 and, preferably, stored in the database 122.

As noted above, the workforce management system (WMS) 126 is a suite of one or more software-driven systems that provide workforce forecasting and scheduling, skill planning and scheduling, multimedia contact management, and the like, and that provides an interface to the database 122.

According to the teachings herein, a workforce management (or equivalent) system such as described above is enhanced for a work environment (e.g., a contact center, a back office, or the like) wherein it is desired to forecast average handling time (AHT) values longer than a handling statistics interval and/or account for the fact that the work items may start in one interval and end in a later interval. Long AHTs are encountered in many types of environments (e.g., IT help desks, product repair centers, software support centers, back office environments that service non-call transactions, and the like) and thus the disclosed invention should not be construed to be limiting to any particular application environment. In a representative embodiment, the functionality described herein is implemented in one or more functional processes 128 executed (e.g., as software) by the central processing computer 120. These processes may be implemented as one or more programs, using appropriate data structures and machine utilities. These processes are now described.

According to an embodiment, an algorithm disclosed herein analyzes forecast AHT and/or forecast contacts/work items in each interval to determine the number of intervals required to complete the contacts forecasted in the interval. In addition, the algorithm determines the work time required in each of the intervals, based on the AHT, the arrival patterns of the work items, the interval length, and the number of intervals required to complete the work items. In a contact center embodiment, the forecasted contact volume and the appropriate work time are recorded in a starting interval (which is the interval the contact is forecasted to be received or handled), as well as an appropriate number of future intervals needed to complete the contact. In this embodiment, this process creates an array (in other words, a data structure) for each interval, which array typically includes the following data: contacts started in the interval, contacts carried over from one or more other intervals, work time in the interval, and work time carried over from one or more other intervals. In one embodiment, staffing requirements are then set equal to a number of contacts in progress during the interval. Alternatively, the staffing requirements for the interval are calculated using a workload, Erlang C, or other known algorithm, where contact volume is equal to the sum of contacts started and contacts carried over, and work time is the sum of work time started and work time carried over (in the interval).

In addition to the carryover of contacts and AHT for the purpose of calculating staffing requirements, according to another disclosed feature, a known WFM schedule generation process preferably is augmented to schedule an agent for intervals after a contact is connected to the agent, up to and including the interval when the contact terminates (based on the AHT of the contact and the arrival time of the contact). To this end, the schedule generation process must be aware of contacts connected to an agent over a long duration, rather than relying solely on prior art techniques, such as net staff analysis per interval. In addition, the schedule generation process preferably schedules agents for new contacts that are forecasted to arrive in an interval when all previously scheduled agents are engaged with contacts in progress. Preferably, the schedule generation process uses a simulation process (as is known in the WFM art) to determine specific agents who are connected to a specific contact that are carried over from one interval to another interval, so that (as appropriate) additional agent(s) can be scheduled to handle the newly arriving contacts. Preferably, scheduled activities (such as breaks, lunches, block scheduling activities, and the like) are not scheduled in an interval if an agent is scheduled to be handling a contact that carries over from interval to interval.

As will be seen, the technique described herein load balances (or, more generally, load shares) the contact assignments during the schedule generation process to ensure a fair distribution of contacts and schedules.

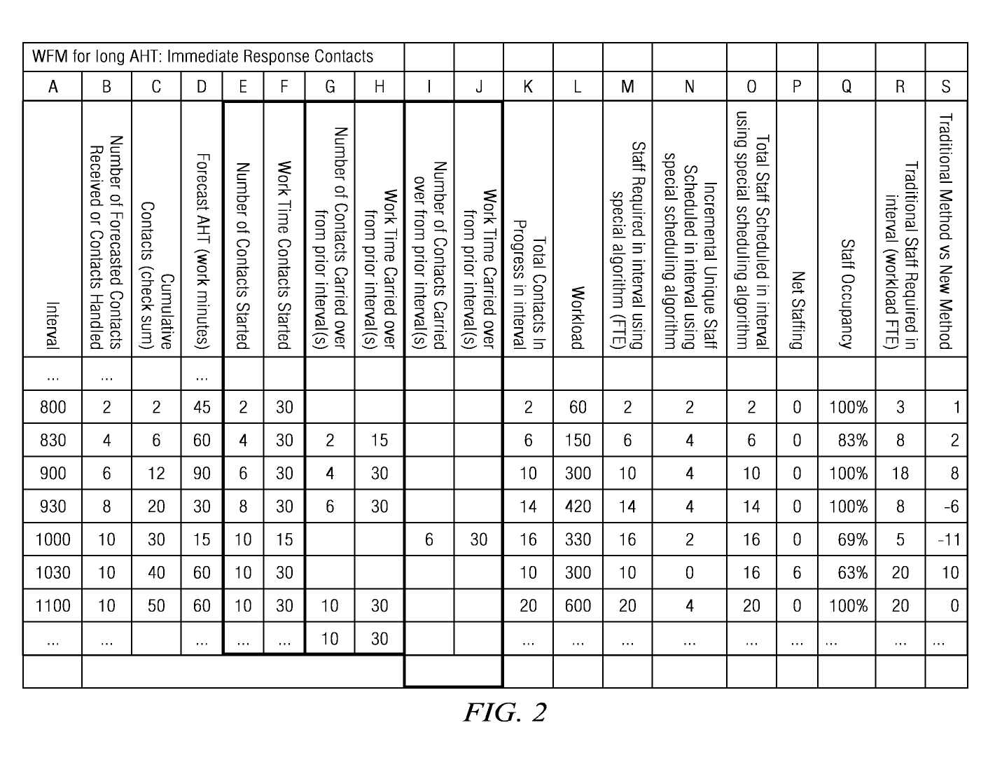

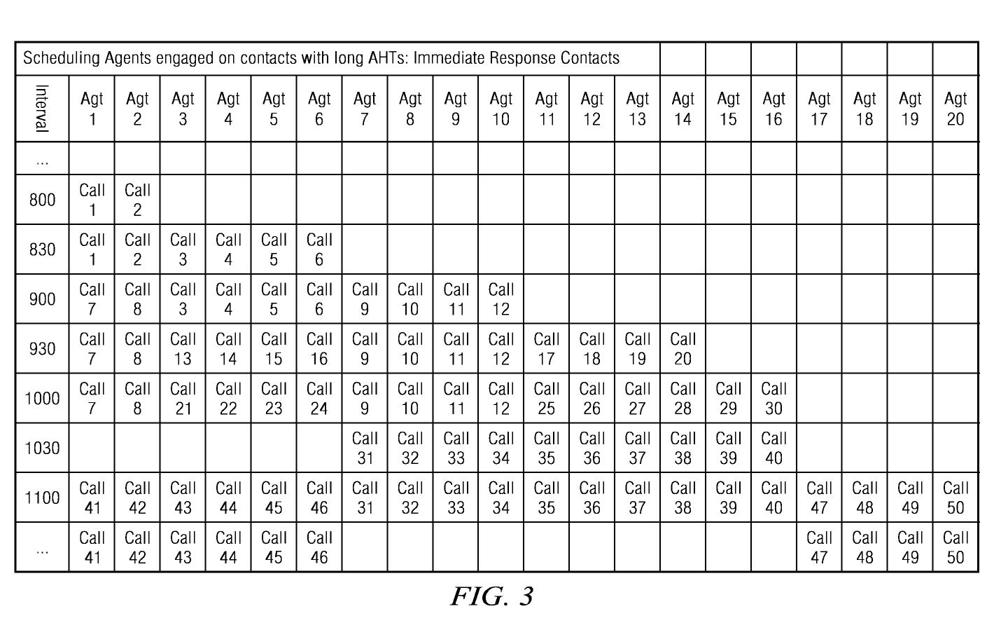

In a first embodiment, a forecast and plan generation process preferably uses the following steps (pseudocode© 2009 IEX) to calculate the staff requirements when AHT is longer than the statistics interval. FIG. 2 is a table illustrating how the disclosed algorithm works to generate the staff requirement calculation during a set of intervals of a particular day. The intervals are shown in the left-most column and represent 30 minute time intervals of a day beginning with an 8:00-8:30 am interval. The thirty (30) minute time interval (the “statistics interval”) is merely representative, as the technique may be used with any statistics interval regardless of its length. According to the disclosure, and as noted above, it is assumed that the AHT is longer than the statistics interval and/or a contact in progress crosses from one interval into following interval(s), whatever that interval may be. FIG. 3 demonstrates the output of a scheduling process for this particular data set to handle the contacts generated by the staff requirement calculation. In this example, the workload ends up being shared by a set of twenty (20) agents, numbered agent 1 (Agt 1) through 20. Of course, the number of agents is not meant to be limiting, and these agents can be distributed within or across a work environment, they may be agents that work remotely or from home, or the like. The particular examples shown in FIG. 2 and FIG. 3 should not be taken to limit in any way the disclosed technique.

Staff Requirement Calculation with Long AHTs: Immediate Response Work Items

The following section describes an algorithm for a staff requirement calculation for “immediate response contacts” for long average handling time (AHT) work items. In particular, according to this aspect of the disclosed subject matter, the forecast and plan generation process of a WFM system preferably uses the following steps to calculate the staff requirements when AHT is longer than the statistics period. As noted above, the steps may be implemented in software, executed by a processor, or in a specialized machine (hardware) that performs the described functionality The references to the “column” represent the columns shown in FIG. 2 and the associated values are set forth in each column as indicated.
Calculate/forecast contactsReceived for all intervals in forecast range using, for example, existing forecasting algorithms (column B)
Calculate/forecast forecastAHT for all intervals in forecast range using existing forecasting algorithms (column D)
Define intervalLength (typically 15 or 30 minutes) (column A)

{
For each interval in forecast range (column A)

If forecastAHT > intervalLength

Determine intervalWorkTime of this interval (column F)

intervalWorkTime = intervalLength

Determine number of extra intervals required to work contacts.

extraIntervals = roundup((forecastAHT-
intervalLength)/intervalLength),0)

{
For each of the extraIntervals

Determine intervalWorkTime (columns H, J)

intervalWorkTime = minOf (intervalLength or (forecastAHT
from this interval − (intervalLength × extraInterval number)))

Determine contactsCarriedOver (columns G, I)

contactsCarriedOver = contactsReceived or contactsHandled (if
applicable) from this interval

}

Else

Determine intervalWorkTime of this interval (column F)

intervalWorkTime = forecastAHT

EndIf
Determine totalContactsInProgress (column K, which is a sum of columns E + G + I )

totalContactsInProgress = (contactsReceived or contactsHandled (if applicable) of
this interval) + ( [symbol] contactsCarriedOver from prior intervals)

Determine staffRequired (column M)

staffRequired = (totalContactsInProgress)

Determine workload (column L)

workload = (contactsReceived of this interval × intervalWorkTime of this interval)
+ [symbol] contactsCarriedOver for each prior interval × intervalWorkTime for each prior
interval)

}

The following description provides additional details regarding each of the identified columns in FIG. 2.

### Column A

The time interval

### Column B

Forecast of contacts received in the interval using, for example, prior art algorithms or custom forecast models.

### Column C

Cumulative contacts forecasted to be received; used as a checksum for scheduling agents (as shown in FIG. 3).

### Column D

Forecast of average handle time (AHT) in the interval using, for example, prior art algorithms or custom forecast models.

### Column E

This value represents a number of contacts received in the interval and that are connected/assigned to an agent to begin working on the contact in the interval.

### Column F

This value represents a total number of minutes that each contact will be worked in the interval. The value is equal to or less than the interval length (typically, but not limited to, 15, 30 or 60 minutes).

### Column G and I

This value represents a number of contacts that were started in prior interval(s) but were not completed in the prior interval(s).
Note: these columns are dynamic; the number of columns is automatically determined by the system, for example, based on the forecast AHT in Column D.

### Column H and J

This value represents a total number of minutes that remained from the AHT in prior interval(s) for contacts that were carried over to the current interval. The value is equal to or less than the interval length (typically—but not limited to—15, 30 or 60 minutes).
Note: these columns are dynamic; the number of columns is automatically determined by the system, for example, based on the forecast AHT in Column D.

### Column K

### Sum of the Values in Columns E+G+I+ . . . .

This value represents a total number of contacts that are consuming agent resources in the interval.

### Column L

### Sum of the Following Values: (E*F)+(G*H)+(I*J)+ . . . .

This value represents the total workload of active contacts in the interval.

### Column M

This value is a total staff required, as expressed in FTE, in the interval using the above-described algorithm. Note that this is not the FTE calculated using traditional methods (Column R), nor is it the workload (Column L) expressed as an FTE. According to the disclosed technique, this value is based on an analysis of active contacts in the interval (Column K).

### Column N

This value represents a number of agents scheduled in the interval that were not scheduled in prior intervals. This value is derived from the disclosed algorithm, which analyzes active contacts in each interval, agent occupancy in each interval, work minutes carried over into each interval, agent scheduling work rules, and other scheduling parameters, such as agent load balancing. FIG. 3 demonstrates the output of the scheduling process for a set of agents.

### Column O

This value represents a cumulative number of agents scheduled in the interval. This value is derived from the disclosed algorithm, which analyzes active contacts in each interval, agent occupancy in each interval, work minutes carried over into each interval, agent scheduling work rules, and other simulation and scheduling parameters such as agent load balancing. As noted above, FIG. 3 demonstrates the output of the scheduling process for this particular data set.

### Column P

### Difference of the Values in Columns O−M

This value represents a net difference between the FTE requirements and the agents scheduled open.

### Column Q

### (L/(O*30)

This value represents occupancy of the scheduled agents. Note that, in intervals where AHT is less than the interval length, lower occupancy occurs even if net staffing is 0 (example: 8:30 and 10:00 intervals)

### Column R

### (B*D)/30

This value is a traditional method of calculating FTE requirements in workforce management systems. It is included for comparison.

### Column S

### R−M

This value is a difference between the traditional method and the method described by this disclosure. As can be seen, the traditional method often causes overstatement of requirements (+10) or understates requirements (−11), depending on the AHT duration and contact volume.

As demonstrated by FIG. 3 the scheduling algorithm herein takes into consideration several factors. Thus, when an agent is engaged on a contact with an AHT that extends into the next interval, the agent is not available to handle new contacts in the next interval(s). An example is shown in the Table where Agent 1 and Agent 2 are engaged with call 1 and call 2 during the 8:00 interval and part of the 8:30 interval. As a result, additional agents thus need to be (and are) scheduled. In this case, Agents 3-6 must be scheduled to handle calls 3-6. Using net staffing analysis (e.g., the sum of squares) for schedule generation, as in the prior art, leads to too many or too few agents scheduled. For example, reducing the overstaffing of the 6 agents during the 10:30 interval (as a means to “balance” staffing) means that calls would not be handled in prior periods for 15 or more minutes. This prior art approach potentially leads to high abandon rates and poor service levels. According to the disclosed algorithm, for example, rather than running agents 1-6 at high occupancy (and potentially miss an opportunity to schedule breaks for these agents), it is better to assign calls 31-36 to agents 7-16 (for example) and assign breaks to agents 1-6. The disclosed algorithm facilitates such a scheduling solution.

As one of ordinary skill in the art will appreciate, the staffing requirements and schedule assignment described herein is driven by contacts in progress, rather than traditional methods. Thus, for example, traditional WFM system methods indicate that 3 agents should be scheduled at 8:00, and 5 more should be scheduled at 8:30. In reality, however, given the nature of the long AHT, only 2 agents need to be scheduled at 8:00, only 4 more are needed at 8:30, and so forth. Likewise, traditional WFM system methods indicate only 5 agents need to be scheduled at 10:00. In reality, however, by this time 16 agents need to be scheduled because several calls are in progress from prior periods—therefore “requiring” those affected agents to remain on schedule. Net staffing analysis alone (as in the prior art) will miss opportunities for scheduling off-phone events during low occupancy intervals. For example, although net staffing is 0 during the 8:30 and 10:00 intervals, low occupancy occurs due to some agents becoming available midway through the interval. These intervals are candidates for scheduling off-phone events for agents 1 and 2 in the 8:00 interval and agents 3-6 and 11-16 for the 10:00 interval.

Furthermore, and as noted above, the disclosed algorithm facilitates “load balancing” of work assignments to agents to ensure agents who are scheduled first (earlier start times or first in a start time) are not necessarily the first to receive a new work item after they finish a work item. For example, the 10:30 interval in FIG. 3 demonstrates that rather than connect the next work item 31 to Agent 1, 2, 3, 4, 5, or 6, the scheduling algorithm connects the work item to Agent 7, who is also available but has handled fewer contacts. This load balancing also creates opportunities to schedule non-work item handling events, such as breaks, for Agents 1, 2, 3, 4, 5, and 6.

The above-described algorithm serves to randomize the arrival of forecasted work items received during an interval to enable that work to be distributed to scheduled agents as needed.

Staff Requirement Calculation with Long AHTs: Deferred Response Work Items

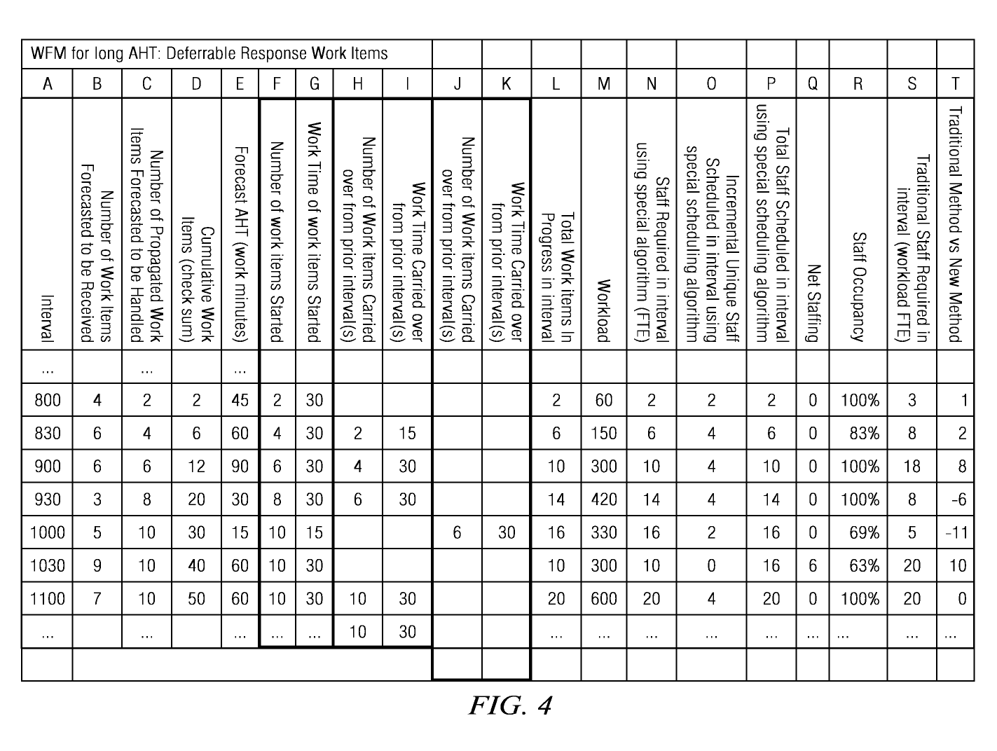

The following section describes an algorithm for a staff requirement calculation for “deferred response contacts” for long average handling time (AHT) work items. This is a second embodiment. Once again, the forecast and plan generation process of a WFM system uses the following steps to calculate the staff requirements when AHT is longer than the statistics period. The steps may be implemented in software, executed by a processor, or in a special purpose (hardware) machine. The references to the “column” represent the columns shown in FIG. 4, and the associated values are set forth in each column as indicated.

Calculate/forecast contactsReceived for all intervals in forecast range using, for example, existing forecasting algorithms (column B)
Analyze staff availability using existing algorithms to determine staffing levels in each interval
Propagate the contactsReceived forecast value into the intervals defined by the Service Level Objective using the relative staffing level in each interval with the Service Level Objective. (The propagated value is the contactsHandled value per interval (column C)
Calculate/forecast forecastAHT for all intervals in forecast range using existing forecasting algorithms (column E)
Define intervalLength (typically 15 or 30 minutes) (column A)

{
For each interval in forecast range (column A)

If forecastAHT > intervalLength

Determine intervalWorkTime of this interval (column G)

intervalWorkTime = intervalLength

Determine number of extra intervals required to work contacts.

extraIntervals = roundup((forecastAHT-
intervalLength)/intervalLength),0)

{
For each of the extraIntervals

Determine intervalWorkTime (columns I, K)

intervalWorkTime = minOf (intervalLength or (forecastAHT
from this interval − (intervalLength × extraInterval number)))

Determine contactsCarriedOver (columns H, J)

contactsCarriedOver = contactsReceived or contactsHandled (if
applicable) from this interval

}

Else

Determine intervalWorkTime of this interval (column G)

intervalWorkTime = forecastAHT

EndIf
Determine totalContactsInProgress (column L, which is a sum of columns F + H + J )

totalContactsInProgress = (contactsReceived or contactsHandled (if applicable) of
this interval) + ( [symbol] contactsCarriedOver from prior intervals)

Determine staffRequired (column N)

staffRequired = (totalContactsInProgress)

Determine workload (column M)

workload = (contactsReceived of this interval × intervalWorkTime of this interval)
+ [symbol] contactsCarriedOver for each prior interval × intervalWorkTime for each prior
interval)

}

The following description provides additional details regarding each of the identified columns in FIG. 4.

### Column A

The time interval

### Column B

Forecast of work items received in the interval using, for example, prior art algorithms or custom forecast models.

### Column C

Forecast of work items handled in the interval using prior art propagation algorithms or custom forecast models. In the case of deferred work items that are propagated into the interval (as known in the prior art), the value may be different from column B.

### Column D

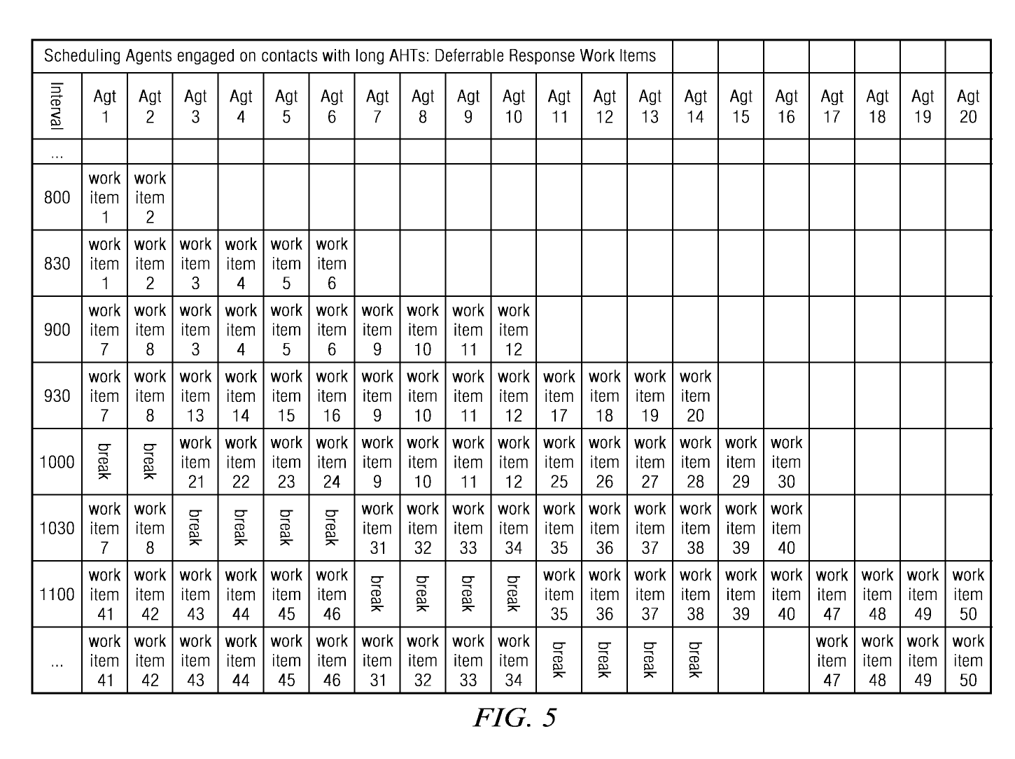

Cumulative work items forecasted to be handed; this is used as a check sum for scheduling agents as shown in FIG. 5.

### Column E

This value represents a forecast of average handle time in the interval using prior art algorithms or custom forecast models.

### Column F

This value represents a number of work items received in the interval and that are connected to an agent to begin working on the work item in the interval. In the case of deferred work items that are propagated into the interval (as known in the art), the value may be different from Column B.

### Column G

This value represents a total number of minutes that each work item will be worked in the interval. The value is equal to or less than the interval length (typically, but not limited to, 15, 30 or 60 minutes).

### Column H and J

This value represents a number of work items that were started in prior interval(s) but were not completed in the prior interval(s).
Note: these columns are dynamic; the number of columns is automatically determined by the system, for example, based on the forecast AHT in Column E.

### Column I and K

This value represents a total number of minutes that remained from the AHT in prior interval(s) for work items that were carried over to the current interval. The value is equal to or less than the interval length (typically—but not limited to—15, 30 or 60 minutes).
Note: these columns are dynamic; the number of columns is automatically determined by the system, for example, based on the forecast AHT in Column E.

### Column L

### Sum of the Values in Columns F+H+J+ . . . .

This value represents a total number of work items that are consuming agent resources in the interval.

### Column M

### Sum of the Following Values: (F*G)+(H*J)+(J*K)+ . . . . .

This value represents the total workload of active work items in the interval.

### Column N

This value is a total staff required, as expressed in FTE, in the interval using the above-described algorithm. Note that this is not the FTE calculated using traditional methods (Column S), nor is it the workload (Column M) expressed as an FTE. According to the disclosed technique, this value is based on an analysis of active work items in the interval (Column L).

### Column O

This value represents a number of agents scheduled in the interval that were not scheduled in prior intervals. This value is derived from the disclosed algorithm, which analyzes active work items in each interval, agent occupancy in each interval, work minutes carried over into each interval, agent scheduling work rules, and other scheduling parameters, such as agent load balancing. FIG. 5 (Table 4) demonstrates the output of the scheduling process for a set of agents.

### Column P

This value represents a cumulative number of agents scheduled in the interval. This value is derived from the disclosed algorithm, which analyzes active work items in each interval, agent occupancy in each interval, work minutes carried over into each interval, agent scheduling work rules, and other simulation and scheduling parameters such as agent load balancing. As noted above, FIG. 5 (Table 4) demonstrates the output of the scheduling process for this particular data set.

### Column Q

### Difference of the Values in Columns P−N

This value represents a net difference between the FTE requirements and the agents scheduled open.

### Column R

### (M/(P*30)

This value represents occupancy of the scheduled agents. Note that, in intervals where AHT is less than the interval length, lower occupancy occurs even if net staffing is 0 (example: 8:30 and 10:00 intervals)

### Column S

### (C*E)/30

This value is a traditional method of calculating FTE requirements in workforce management systems. It is included for comparison.

### Column T

### S−N

This value is a difference between the traditional method and the method described by this disclosure. As can be seen, the traditional method often causes overstatement of requirements (+10) or understates requirements (−11), depending on the AHT duration and work item volume.

As demonstrated by the “Table 4” in FIG. 5, the scheduling algorithm in this embodiment takes into consideration several factors. Thus, when an agent is engaged on a work item with an AHT that extends into the next interval, the agent is not available to handle new work items in the next interval(s). An example is shown in the Table where Agent 1 and Agent 2 are engaged with work item 1 and work item 2 during the 8:00 interval and part of the 8:30 interval. As a result, additional agents need to be (and are) scheduled. In this case, Agents 3-6 must be scheduled to handle work items 3-6. Using net staffing analysis (e.g., the sum of squares) for schedule generation, as in the prior art, leads to too many or too few agents scheduled. For example, reducing the overstaffing of the 6 agents during the 10:30 interval (as a means to “balance” staffing) means that work items would not be handled in prior periods for 15 or more minutes. This prior art approach potentially leads to high abandon rates and poor service levels. According to the disclosed algorithm, for example, rather than running agents 1-6 at high occupancy (and potentially miss an opportunity to schedule breaks for these agents), it is better to assign work items 31-36 to agents 7-16 (for example) and assign breaks to agents 1-6. The disclosed algorithm facilitates such a scheduling solution.

As one of ordinary skill in the art will appreciate, and as noted above in the first embodiment, the staffing requirements and schedule assignment described herein is driven by work items in progress, rather than traditional methods. Thus, for example, traditional WFM system methods indicate that 3 agents should be scheduled at 8:00, and 5 more should be scheduled at 8:30. In reality, however, given the nature of the long AHT, only 2 agents need to be scheduled at 8:00, only 4 more are needed at 8:30, and so forth. Likewise, traditional WFM system methods indicate only 5 agents need to be scheduled at 10:00. In reality, however, by this time 16 agents need to be scheduled because several work items are in progress from prior periods—therefore “requiring” those affected agents to remain on schedule. Net staffing analysis alone (as in the prior art) will miss opportunities for scheduling off-phone events during low occupancy intervals. For example, although net staffing is 0 during the 8:30 and 10:00 intervals, low occupancy occurs due to some agents becoming available midway through the interval. These intervals are candidates for scheduling off-phone events for agents 1 and 2 in the 8:00 interval and agents 3-6 and 11-16 for the 10:00 interval.

With deferrable work items, it is possible to pause the work item and schedule an off-phone event (such as a break after x minutes of work), and then resume the work item upon completion of the off-phone event. The scheduling algorithm preferably accounts for the deferrable nature of the work item so that scheduling rules can be honored without needing to add additional agents.

Furthermore, and as described above, the disclosed algorithm facilitates “load balancing” of work assignments to agents to ensure agents who are scheduled first (earlier start times or first in a start time) are not necessarily the first to receive a new contact after they finish a contact. For example, the 1030 interval in FIG. 3 demonstrates that rather than connect the next work item 31 to Agent 1, 2, 3, 4, 5, or 6, the scheduling algorithm connects the work item to Agent 7 who is also available, but has handled fewer contacts. This load balancing also creates opportunities to schedule non-contact handling events such as breaks for Agents 1, 2, 3, 4, 5, and 6.

The above-described algorithm serves to randomize the arrival of forecasted work items received during an interval to enable that work to be distributed to scheduled agents as needed.

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

The disclosed techniques can take the form of an entirely hardware embodiment, an entirely software embodiment, or an embodiment containing both hardware and software elements. In one preferred embodiment, the algorithm is implemented in software executing in one or more server machines, such as a multimedia server. The disclosed technique (or portions thereof) may take the form of a computer program product accessible from a computer-usable or computer-readable medium providing program code for use by or in connection with a computer or any instruction execution system. A computer-usable or computer readable medium can be any device or apparatus that can include or store the program for use by or in connection with the instruction execution system, apparatus, or device. The medium is tangible. The medium can be an electronic, magnetic, optical, or the like. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

While given components of the system have been described separately, one of ordinary skill will appreciate that some of the functions may be combined or shared in given instructions, program sequences, code portions, and the like.

A skilled artisan will appreciate that the subject matter concerns future planning; thus, references herein to a work item “in progress” or work that “continues from one or more prior intervals” refers to an anticipated future event in the work environment.

Having described our invention, what we now claim is as follows.

1. A computer-readable medium having stored thereon instructions that, when executed, direct a workforce management (WFM) system to perform the following method with respect to work items, where given work items cross from one interval into at least one or more following intervals:
for each interval in a forecast range:
determine a total number of work items, wherein the total number of work items is based in part on work that continues from one or more prior intervals; and
for the interval, determining staff required based on the total number of work items in progress.

2. The medium as described in claim 1 wherein the total number of work items is based on work items received or handled during the interval plus a sum of work that continues from the one or more prior intervals.

3. The medium as described in claim 2 wherein the work items received in the interval are work items that are forecast for an agent to begin working on during the interval.

4. The medium as described in claim 1 wherein the total number of work items is based at least in part on one or more work items that were started in the one or more prior intervals but that were not completed in the prior intervals.

5. The medium as described in claim 1 wherein the interval length is a statistics interval.

6. The medium as described in claim 1 wherein the forecast AHT is derived from a set of intervals in a forecast range.

7. The medium as described in claim 1 wherein the method further includes determining a workload for the interval.

8. The medium as described in claim 1 wherein the staff is expressed as an full time equivalent (FTE) unit.

9. The medium as described in claim 1 further including generating at least one agent schedule based on the staff required for each of a set of intervals in the forecast range.

10. The medium as described in claim 1 wherein a work item crosses from one interval to one or more following intervals because a forecast average handling time (AHT) is greater than or equal to an interval length, or because the work item is forecast to arrive late in an interval and cannot be completed before the interval ends.

11. A computer-readable medium having stored thereon instructions that, when executed, direct a workforce management (WFM) system to perform the following planning and scheduling method:
during a first stage:
for each interval in a forecast range, if a forecast average handling time (AHT) is greater than an interval length or a work item crosses from one interval into following interval(s):
determine a total number of work items in progress, wherein the total number of work in progress is based in part on items carried over from one or more prior intervals; and
for the interval, determining staff required based on the total number of work items in progress;
during a second stage:
generating at least one agent schedule based on the staff requirement for each of a set of intervals in the forecast range.

12. A computer-readable medium having stored thereon instructions that, when executed, direct a workforce management (WFM) system to generate a set of one or more agent schedules for agents that are to be scheduled to handle a work item, wherein the work item has an average handling time greater than a statistics interval, or the work item will be handled across more than one interval, by:
for each interval in a forecast range, determining a total number of work items and a number of staff required to handle the total number of work items; and
generating at least one agent schedule based on the staff requirement for each of a set of intervals in the forecast range.

13. The medium as described in claim 12 further including assigning the set of agents to the agent schedule.

14. The medium as described in claim 12 wherein the agent schedule is also based on at least one agent scheduling work rule.

15. The medium as described in claim 12 wherein the agent schedule is also based an agent occupancy value for the interval.

16. The medium as described in claim 12 wherein the agent schedule is also based on a schedule parameter.

17. The medium as described in claim 1 wherein the work item has an associated response that is deferrable to a future time period.

18. The medium as described in claim 11 wherein the work item has an associated response that is deferrable to a future time period.

19. The medium as described in claim 12 wherein the work item has an associated response that is deferrable to a future time period.

20. The medium as described in claim 12 wherein the work item is a contact in a content center environment.
